(19) United States
(12) Patent Application Publication
(10) Pub. No.: US 2015/0254700 A1
(43) Pub. Date: Sep. 10, 2015

(54) Incentivize Reviews Using Purchase Proof Based on Mobile Payment Data

(71) Applicant: Google Inc., Mountain View, CA (US)

(72) Inventor: Vardhman Jain, San Francisco, CA (US)

(73) Assignee: Google Inc., Mountain View, CA (US)

(21) Appl. No.: 14/230,353

(22) Filed: Mar. 31, 2014

Related U.S. Application Data
(60) Provisional application No. 61/948,146, filed on Mar. 5, 2014.

(51) Int. Cl. G06Q 30/02

(52) U.S. Cl. CPC G06Q 30/0217; G06Q 30/0215

(57) ABSTRACT

Systems and methods for incentivizing reviews are provided. One example method includes obtaining, by one or more computing devices, data from a mobile payment system indicating that a user has performed a transaction with a commercial entity, the transaction having a transaction time. The method includes obtaining, by the one or more computing devices, location data associated with one or more mobile computing devices associated with the user. The method includes determining, by the one or more computing devices, whether the user was located at the commercial entity at the transaction time based at least in part on the location data. The method includes providing, by the one or more computing devices, an incentive for the user to provide a review of the commercial entity when it is determined that the user was located at the commercial entity at the transaction time.

### PRIORITY CLAIM

The present application claims the benefit of priority of U.S. Provisional Patent Application Ser. No. 61/948,146, titled Incentivize Reviews Using Purchase Proof Based on Mobile Payment Data, filed Mar. 5, 2014, which is incorporated herein by reference for all purposes.

### FIELD

The present disclosure relates generally to incentivizing reviews. In particular, the present disclosure is directed to systems and methods for incentivizing reviews using purchase proof based on mobile payment system data and device location data.

### BACKGROUND

Review platforms can provide an opportunity for users to contribute or browse reviews of commercial entities or their products. For example, after eating at a particular restaurant, a user can visit a webpage in the review platform that corresponds to the particular restaurant and can contribute a review. The review can be numeric (e.g. 6/10 or 3 stars out of 5), textual (e.g. “great wine selection, but poor service”), or other formats.

Some review platforms can also offer functionality for a user to upload photos, tag friends, or other interactive features. Thus, it is apparent that review platforms can be embedded within or an extension or feature of social media platforms, mapping applications, or some combination of mapping, social, and review services.

Furthermore, once a review platform has accumulated a significant number of reviews it can be a useful resource for users to identify new entities or locales to visit or experience. For example, a user can visit the review platform to search for a restaurant at which to eat, a store at which to shop, or a place to have drinks with friends. The review platform can provide search results based on location, quality according to the reviews, pricing, and/or keywords included in textual reviews.

However, one problem associated with launching a new review platform is obtaining a significant number of valid reviews of different commercial entities or products. In particular, a review platform with few reviews is not attractive for users searching for new entities or locales to visit. For example, if the review platform does not have reviews of restaurants in a user's neighborhood, then the review platform is not very useful resource for that user. Therefore, the user is unlikely to visit and interact with such review platform.

Furthermore, if the user is unlikely to visit and interact with the review platform, then the user is also unlikely to invest time in providing the review herself. Thus, it can be difficult for a new or lagging review platform to gain social momentum. In particular, the review platform generally requires a critical mass of reviews to become used widely enough that it is attractive for users to continue returning and contributing to the review platform.

One solution to the continuing need for reviews is for the review platform to offer an incentive to users to contribute a review. For example, the incentive can be monetary, social, linked to a game, or other forms of incentives. Thus, by providing an incentive to the user, the review platform can solicit additional reviews and gain momentum.

However, offering incentives for users to provide reviews can be subject to abuse and targeted for manipulation. In particular, one key aspect of reviews is that they be valid. In other words, a review is only valid if the reviewer has actually visited or experienced the commercial entity or the product being reviewed.

Therefore, incentives should only be provided for reviews that meet this criteria. Otherwise, the review platform may incentivize reviews that are more harmful that beneficial. As such, systems and methods are needed for ensuring that incentives are only provided to users who are able to contribute valid reviews.

### SUMMARY

Aspects and advantages of the present disclosure will be set forth in part in the following description, or may be obvious from the description, or may be learned through practice of embodiments of the present disclosure.

One example aspect of the present disclosure is directed to a method for incentivizing reviews. The method includes obtaining, by one or more computing devices, data from a mobile payment system indicating that a user has performed a transaction with a commercial entity, the transaction having a transaction time. The method includes obtaining, by the one or more computing devices, location data associated with one or more mobile computing devices associated with the user. The method includes determining, by the one or more computing devices, whether the user was located at the commercial entity at the transaction time based at least in part on the location data. The method includes providing, by the one or more computing devices, an incentive for the user to provide a review of the commercial entity when it is determined that the user was located at the commercial entity at the transaction time.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling description of the present disclosure, directed to one of ordinary skill in the art, is set forth in the specification, which makes reference to the appended figures, in which:

FIG. 1 depicts an example user interface according to an example embodiment of the present disclosure;

FIG. 2 depicts an example system according to an example embodiment of the present disclosure;

FIG. 3 depicts a flow chart of an example method for incentivizing reviews according to an example embodiment of the present disclosure; and

FIG. 4 depicts a flow chart of another example method for incentivizing reviews according to an example embodiment of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

### Overview

Generally, the present disclosure is directed to systems and methods for identifying proof of a user transaction with a commercial entity prior to offering an incentive for the user to provide a review of the commercial entity. In particular, in some embodiments, the proof of purchase can be identified based on a comparison of location data associated with one or more of the user's mobile computing devices and data obtained from a mobile payment system that evidences a transaction between the user and the commercial entity. Thus, for example, if the location data indicates that the user was located at the commercial entity at the time of a transaction time provided by the mobile payment system data, then an incentive can be offered to the user to provide a review of the commercial entity. The commercial entity can be a third-party seller that is unaffiliated with the mobile payment system. In other embodiments, the data obtained from the mobile payment system can provide proof of purchase for a plurality of products purchased in a single transaction that was processed by the mobile payment system. One of the products can be selected and a review of the selected product can be incentivized. Therefore, incentives for user reviews can be offered to only those users that actually transacted with the commercial entity being reviewed. In such fashion, the incentivized reviews are more likely to be valid reviews.

More particularly, according to an aspect of the present disclosure, the systems and methods of the present disclosure can obtain data from a mobile payment system. For example, the mobile payment system can provide and operate a virtual wallet for a user. The virtual wallet can store financial information such as, for example, credit card numbers. Alternatively or additionally, the virtual wallet can hold a balance of currency (e.g. U.S. dollars) for the user.

The user can use the mobile payment system to complete transactions with various commercial entities. As an example, in some embodiments, a mobile computing device of the user (e.g. a smartphone) can provide information to the commercial entity at a point-of-sale that identifies the virtual wallet associated with the user. For example, the mobile computing device can communicate the information to the commercial entity using a near-field communication component, by providing a barcode for the commercial entity to scan, or via other communication methods.

As another example, in some embodiments, the mobile payment system can provide the user with a card or other device that has the identifying information stored thereon. The user can employ the card or other device to communicate the identifying information to the commercial entity at the point-of-sale.

In yet other embodiments, the mobile payment system can be used to complete transactions that occur online or remotely over a network. Thus, for example, the user can provide information to the commercial entity via a website or other portal that identifies a virtual wallet associated with the user and provided by the mobile payment system.

The commercial entity can then contact the mobile payment system over a network (e.g. the Internet) and supply the identifying information received from the user or the user's computing device along with a requested payment amount. The mobile payment system can validate the request, make the appropriate payment to the commercial entity, and then charge the payment amount to the user's virtual wallet.

For example, the mobile payment system can use credit card information stored in the virtual wallet to charge the payment amount to a particular credit card authorized or selected by the user. Alternatively, the mobile payment system can deduct the payment amount from the balance of currency held in the virtual wallet.

Regardless of the particular methodology used by the mobile payment system and user to perform the transaction, the mobile payment system can generate and store data that evidences the transaction between the user and the commercial entity. In particular, in some embodiments, each transaction can have an associated transaction time and transaction location that is evidenced by the mobile payment system data. Generally, for transactions in which the point-of-sale is a storefront of the commercial entity (e.g. an “on-site sale”), the transaction location can be the location of such storefront.

In some embodiments, the transaction data can identify or otherwise indicate a plurality of different products purchased by the user from a third party commercial entity. For example, the transaction data can include a receipt or other itemized listing of purchased products (e.g. product-identifying barcodes or stock keeping units).

One of the plurality of products can be selected and the user can be incentivized to provide a review of the selected product, as will be discussed further below. The product can be selected based on review data such as a number or quality of existing reviews. For example, a product that has few or low quality existing reviews can be selected so that the user is incentivized to supplement the existing reviews.

According to another aspect of the present disclosure, in some embodiments, a system implementing the present disclosure can also obtain location data associated with one or more mobile computing devices associated with a user. As an example, the user can have a smartphone, tablet, wearable computing device, or other mobile computing device that is associated with the user. Each mobile computing device can periodically provide a location report that indicates the mobile computing device's location at a particular time. As such, in some embodiments, the location reports associated with each of the user's mobile computing devices can be obtained.

Thus, in some embodiments, in order to obtain the benefits of the techniques described herein, the user may be required to allow the collection and analysis of mobile payment system information and location information associated with the user or her device. Therefore, in some embodiments, users may be provided with an opportunity to control whether programs or features collect such information. If the user does not allow collection and use of such information, then the user may not receive the benefits of the techniques described herein. The user can also be provided with tools to revoke or modify consent. In addition, certain information or data can be treated in one or more ways before it is stored or used, so that personally identifiable information is removed.

According to yet another aspect of the present disclosure, in embodiments in which location data is also obtained, the data obtained from the mobile payment system and the location data can be compared to determine whether the user was located at a commercial entity at the time of a transaction between the user and the commercial entity evidenced by the mobile payment system data.

As an example, it can be determined whether one or more of a plurality of location reports provided by the user's mobile computing devices both identifies a geolocation (e.g. a latitude and longitude) that is within a threshold distance from the commercial entity and provides a time that is within a threshold amount of time from the transaction time.

If it is determined that the user was located at a commercial entity at the time of a transaction, then an incentive can be offered to the user to provide a review of the commercial entity or a product purchased from the commercial entity. As an example, the incentive can be offered via a user interface of the mobile payment system. The review can be provided to a review platform. Alternatively, the incentive can be offered via a user interface of the review platform.

More particularly, in some embodiments, the mobile payment system and the review platform can be operated by the same entity. Thus, the two systems can operate together to provide an incentive to be collected via the mobile payment system in exchange for the user interacting with the review platform. Furthermore, in some embodiments, the entity operating the mobile payment system and the review platform can be unassociated or otherwise unaffiliated with the commercial entity.

According to another aspect of the present disclosure, the incentive can be awarded to the user when the user provides the requested review of the commercial entity or selected product. As an example, the incentive can be a coupon or other commercial offer. Upon completion of the review, the coupon can be stored in the user's virtual wallet.

As another example, the incentive can be an amount of currency, with the amount being based on the value of the transaction. For example, the incentive can be a “cash-back” offer of 1% of the transaction value. Upon completion of the review, the balance of the user's virtual wallet can be incremented by the amount of currency. In the instance that the incentive is offered for review of a particular one of a plurality of products rather than the commercial entity, then the amount of incentive can be based on the purchase price of the particular product, and not the transaction value as a whole.

Thus, mobile payment systems can be used to identify a proof of purchase for a user with respect to an entity or product to be reviewed. For example, in some embodiments, mobile payment system data and location data associated with a user's mobile computing devices can be used to verify that a user was at a commercial entity at the time a transaction between the user and the commercial entity occurred. In such instances, an incentive can be offered to the user to provide a review of the commercial entity. As another example, in some embodiments, the mobile payment system data can evidence a transaction that includes a plurality of products. One of the plurality of products can be selected based on review data and a review of the selected product can be incentivized.

### Example User Interfaces

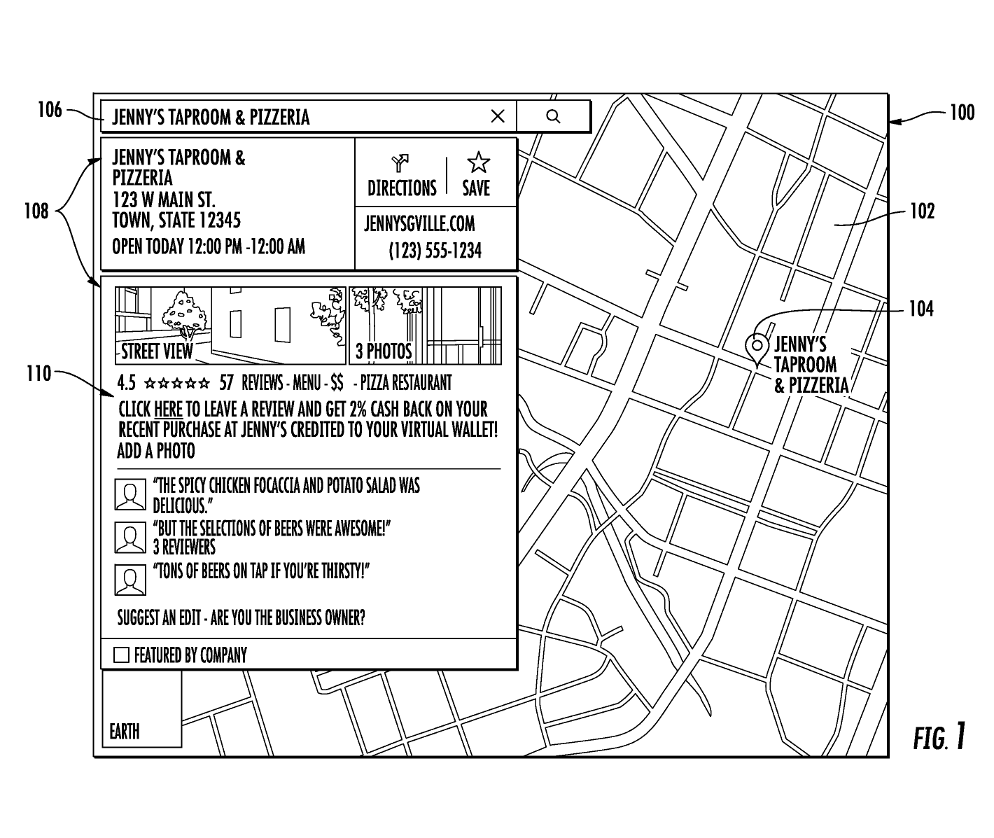

With reference now to the FIGS., example embodiments of the present disclosure will be discussed in further detail. FIG. 1 depicts an example user interface 100 according to an example embodiment of the present disclosure. In particular, FIG. 1 depicts example user interface 100 of a mapping application that includes a review platform.

User interface 100 can include a map 102. One or more markers can be shown on the map to indicate the respective locations of points of interest, including commercial entities. As an example, a marker 104 has been placed on map 102 to show the location of a commercial entity: “Jenny's Taproom & Pizzeria.”

More particularly, the user has searched for “Jenny's Taproom & Pizzeria” using a search bar 106. As a result, user interface 100 has provided map 102 including marker 104.

In addition, user interface 100 has provided additional information 108 about the requested commercial entity. For example, information 108 can include an address, operating hours, a web address, a phone number, a summary of one or more available reviews, and interactive features that allow the user to retrieve directions, save as a favorite, view interior or exterior imagery, and/or obtain a menu. It will be appreciated that the information 108 is provided as an example. Therefore, many other features or information can be provided.

According to an aspect of the present disclosure, an incentive can be offered to the user via user interface 100. In particular, the incentive can be offered in exchange for the user providing a review of a commercial entity.

Thus, as an example, user interface 100 includes an offer 110 of an incentive for the user to review Jenny's Taproom and Pizzeria. In particular, the offer 110 includes two percent cash back on a recent purchase the user has made at Jenny's Taproom and Pizzeria if the user contributes a review.

The cash back would be credited to a virtual wallet associated with the user. Thus, in some embodiments, the incentive can be collected by the user via a mobile payment system operated by the same entity as the review platform. In particular, in some embodiments, the incentive can be collected by the user via the same mobile payment system from which data is obtained to ensure that the user is capable of contributing a valid review.

Thus, user interface 100 provides an example offer 110 of an incentive for a user to provide a review in the context of a mapping application. However, user interface 100 is provided as an example only. It will be appreciated that the offer 110 can alternatively be included in a user interface of a social media platform, a user interface of a mobile payment system, in search results, or other locations or contexts.

Furthermore, the incentive included in offer 110 is also provided only as an example. Alternative incentives can include a defined amount of currency, points or items in a game, social media awards or titles, access to new features, or other suitable incentives.

### Example Systems

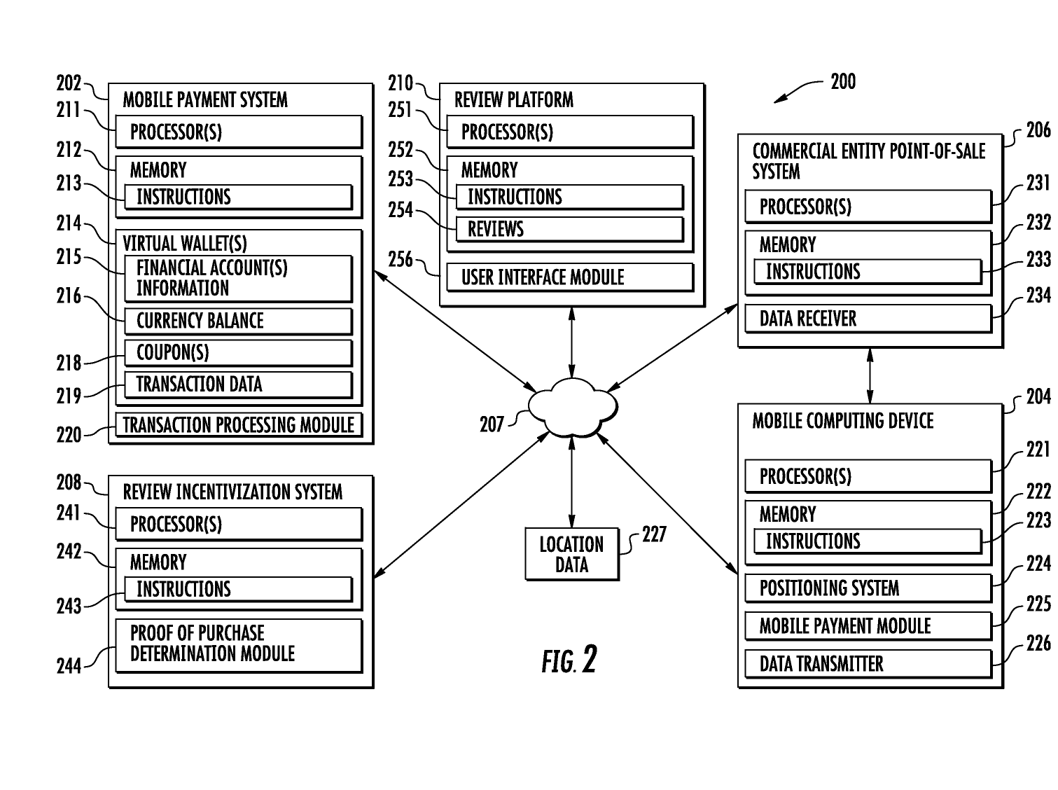

FIG. 2 depicts an example system 200 according to an example embodiment of the present disclosure. System 200 can include a mobile payment system 202, mobile computing device 204, and a commercial entity point-of-sale system 206 in communication over a network 207.

Mobile payment system 202 can be implemented using one or more computing devices, such as, for example, server computing devices. In the instance that mobile payment system 202 includes multiple computing devices, the computing functions can be distributed according to any computing architecture, including any combination of parallel and sequential computing architectures. Mobile payment system 202 can include one or more processors 211 and a memory 212.

The processor(s) 211 can be any suitable processing device, such as a microprocessor, microcontroller, integrated circuit, or other suitable processing device. The memory 212 can include any suitable computing system or media, including, but not limited to, non-transitory computer-readable media, RAM, ROM, hard drives, flash drives, or other memory devices.

The memory 212 can store information accessible by processor(s) 211, including instructions 213 that can be executed by processor(s) 211. The instructions 213 can be any set of instructions that when executed by the processor(s) 211, cause the processor(s) 211 to provide desired functionality, including, for example, performing aspects of the present disclosure.

Mobile payment system 202 can provide or operate one or more virtual wallets 214 for one or more respective users. Generally, the virtual wallet 214 for each user can allow the user to store information concerning debit cards, credit cards, loyalty cards, gift cards, logins, coupons, or other items, as well as allow the user to redeem sales promotions using their mobile computing device. In addition, the virtual wallet 214 can hold a balance of currency (e.g. United States dollars, foreign currency, cryptocurrency, etc.). Thus, in some embodiments, the virtual wallet 214 for each user can include or store financial account information 215 (e.g. credit card numbers), a currency balance 216, and coupons 218.

Mobile payment system 202 can be used by a user to complete transactions with various commercial entities. As an example, in some embodiments, a mobile computing device 204 of the user can provide information to a commercial entity point-of-sale system 206 that identifies the virtual wallet 214 associated with the user. In other embodiments, the mobile payment system 202 can process a transaction between a user and the commercial entity system 206 that occurs online or over a network. Thus, for example, the user can provide information to the commercial entity system 206 via a website or other portal that identifies the virtual wallet 214. The point-of-sale system 206 can then use the received information to complete a transaction with mobile payment system 202 over network 207 on behalf of the user.

Thus, mobile payment system 202 can include a transaction processing module 220. Transaction processing module 220 can receive a request for completion of a transaction (e.g. a request for payment of a transaction value) from the commercial entity point-of-sale system 206. Transaction processing module 220 can validate the request, make the appropriate payment to the commercial entity point-of-sale system 206, and then charge the payment amount to the virtual wallet 214 associated with the user identified by the commercial entity point-of-sale system 206.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

Mobile computing device 204 can include one or more processors 221 and a memory 222. As examples, mobile computing device 204 can be a smartphone, a tablet, a music player, a wearable computing device such as computing-enabled eyeglasses, a smartwatch, or other mobile computing device.

The processor(s) 221 can be any suitable processing device, such as a microprocessor, microcontroller, integrated circuit, or other suitable processing device. The memory 222 can include any suitable computing system or media, including, but not limited to, non-transitory computer-readable media, RAM, ROM, hard drives, flash drives, or other memory devices.

The memory 222 can store information accessible by processor(s) 221, including instructions 223 that can be executed by processor(s) 221. The instructions 223 can be any set of instructions that when executed by the processor(s) 221, cause the processor(s) 221 to provide desired functionality, including, for example, performing aspects of the present disclosure.

Likewise, commercial entity point-of-sale system 206 can include one or more processors 231 and a memory 232. As examples, point-of-sale system 206 can be a checkout terminal, terminal reader, server(s) performing online sales, or other device(s) for conducting sales for a commercial entity.

The processor(s) 231 can be any suitable processing device, such as a microprocessor, microcontroller, integrated circuit, or other suitable processing device. The memory 232 can include any suitable computing system or media, including, but not limited to, non-transitory computer-readable media, RAM, ROM, hard drives, flash drives, or other memory devices.

The memory 232 can store information accessible by processor(s) 231, including instructions 233 that can be executed by processor(s) 231. The instructions 233 can be any set of instructions that when executed by the processor(s) 231, cause the processor(s) 231 to provide desired functionality, including, for example, performing aspects of the present disclosure.

According to an aspect of the present disclosure, mobile computing device 204 can include a mobile payment module 225 for conducting a transaction using mobile payment system 202 via commercial entity point-of-sale system 206. In some embodiments, the mobile payment module 225 can be an application that the user opens on the mobile computing device 204 to verify the user's identity and receive user authorization. For example, in some implementations, the user must enter a PIN or passcode to authorize mobile payment module 225 to perform a transaction.

In some embodiments, after the mobile payment module 225 has been authorized to perform a transaction, the mobile payment module 225 can transmit identifying information to the point-of-sale system 206. For example, the transmitted information can identify a particular virtual wallet 214 to commercial entity point-of-sale system 206. Alternatively or additionally, the transmitted information can identify a username, user identifier, or other information that allows mobile payment system 202 to identify the user.

As such, mobile computing device 204 can include a data transmitter 226 for transmitting the identifying information to commercial entity point-of-sale system 206. Likewise, commercial entity point-of-sale system 206 can include a data receiver 234 for receiving the data transmitted by data transmitter 226.

As an example, the data transmitter 226 and data receiver 234 can be components for performing near-field communication. For example, the user can swipe or tap the mobile computing device 204 to the data receiver 234 to transfer the information.

As another example, data transmitter 226 can include a component for generating a barcode (e.g. a QR-code) to be shown on a display of the mobile computing device 204. As such, the data receiver can be a component for scanning and decoding the barcode.

As other examples, the data transmitter 226 and data receiver 234 can transmit information according to any other suitable transmission method, including, for example, an audio signal, an infrared signal, using a suitable protocol over a local network, via magnetic induction, or other communications methods. Further, in some embodiments, commercial entity point-of-sale system 206 provides information to mobile computing device 204.

In other embodiments, the mobile payment system 202 can provide the user with a card or other device (e.g. an electronic fob, RFID tag, security token, etc.) that has the identifying information stored thereon. The user can employ the card or other device to communicate the identifying information to the commercial entity point-of-sale system 206.

In some embodiments, once the commercial entity point-of-sale system 206 has received identifying information from a mobile computing device 204, the point-of-sale system 206 can then contact the mobile payment system 202 over network 207. For example, the point-of-sale system 206 can supply the identifying information along with a requested payment amount. In some implementations, the point-of-sale system 206 can also provide an itemized listing of a plurality of products included in the transaction (e.g. a receipt).

Mobile payment system 202 can implement transaction processing module 220 to validate the request, make the appropriate payment to the commercial entity, and then charge the payment amount to the user's virtual wallet 214. As an example, the transaction processing module 220 can use the financial account information 215 stored in the virtual wallet 214 to charge the payment amount to a particular financial account (e.g. credit card) authorized or selected by the user. Alternatively, the transaction processing module 220 can deduct the payment amount from the currency balance 216 held in the virtual wallet 214.

Regardless of the particular methodology used by the mobile payment system 202 and user to perform the transaction, the mobile payment system 202 can generate and store transaction data 219 that evidences the transaction between the user and the commercial entity. For example, each transaction can have an associated transaction time and transaction location that is evidenced by the transaction data 219. As another example, the transaction data 219 can be a receipt or other itemized listing of products purchased by the transaction.

According to another aspect of the present disclosure, in some embodiments, location data received from one or more mobile computing devices 204 associated with a particular user and stored in a location data database 227. As an example, if a user chooses to participate in the services of the present disclosure, one or more of the user's mobile computing devices 204 can implement a positioning system 224 to determine its current location and then periodically provide a location report to a server computing device for storage in database 227. For example, each location report can identify a geolocation and time.

The positioning system 224 can be any device or circuitry for analyzing the position of the device 204. For example, the positioning system 224 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

According to yet another aspect of the present disclosure, a review incentivization system 208 and a review platform 210 can be in communication over network 207 with mobile payment system 202, mobile computing device 204, and commercial entity point-of-sale system 206.

Review incentivization system 208 can be implemented using one or more computing devices, such as, for example, server computing devices. In the instance that review incentivization system 208 includes multiple computing devices, the computing functions can be distributed according to any computing architecture, including any combination of parallel and sequential computing architectures. Review incentivization system 208 can include one or more processors 241 and a memory 242.

The processor(s) 241 can be any suitable processing device, such as a microprocessor, microcontroller, integrated circuit, or other suitable processing device. The memory 242 can include any suitable computing system or media, including, but not limited to, non-transitory computer-readable media, RAM, ROM, hard drives, flash drives, or other memory devices.

The memory 242 can store information accessible by processor(s) 241, including instructions 243 that can be executed by processor(s) 241. The instructions 243 can be any set of instructions that when executed by the processor(s) 241, cause the processor(s) 241 to provide desired functionality, including, for example, performing aspects of the present disclosure.

According to an aspect of the present disclosure, review incentivization system 208 can include a proof of purchase determination module 244. Review incentivization system 208 can implement proof of purchase determination module 244 to identify users to which an incentive should be provided for contributing a review of a commercial entity or product.

As an example, in some embodiments, proof of purchase determination module 244 can be implemented to determine a proof of purchase for a user based on a comparison of location data 227 associated with one or more of the user's mobile computing devices 204 and transaction data 219 obtained from mobile payment system 202 that evidences a transaction between the user and the commercial entity.

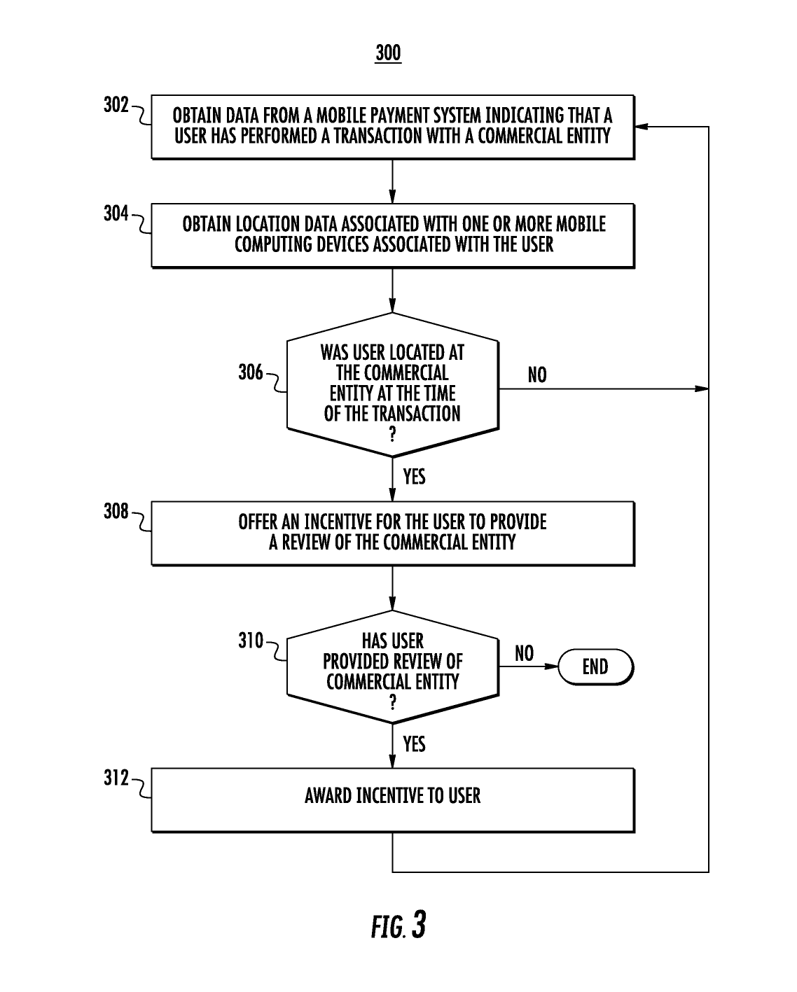

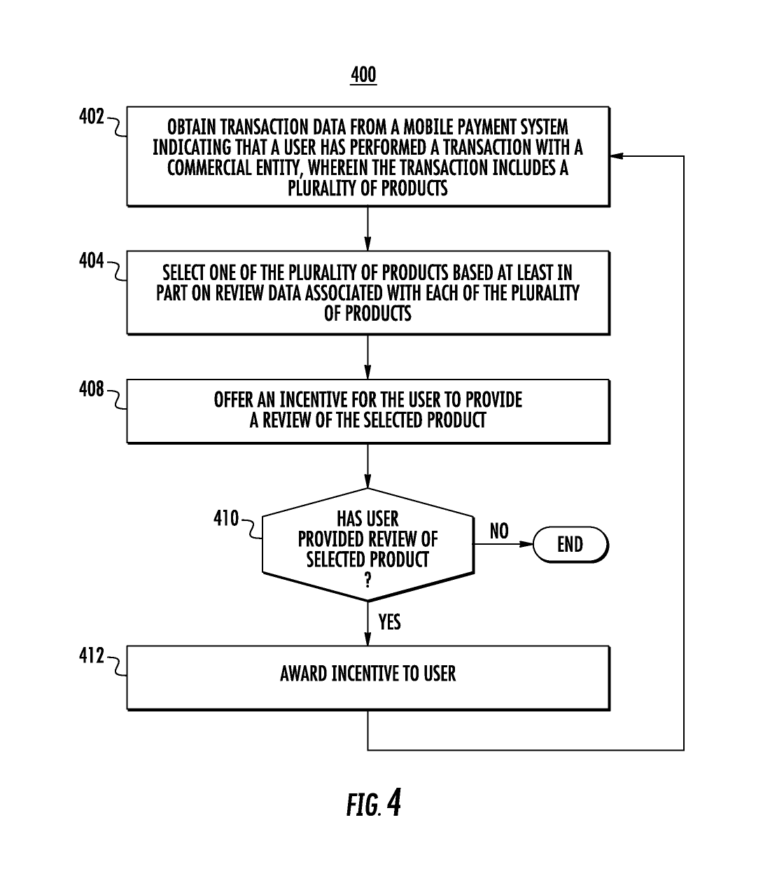

As another example, in some embodiments, proof of purchase determination module 244 can be implemented to determine a proof of purchase for a product based on transaction data 219 obtained from mobile payment system 202 that evidences a purchase of a plurality of products by the user from the commercial entity. Thus, proof of purchase determination module 244 can be implemented to perform aspects of method (300) of FIG. 3 and/or aspects of method (400) of FIG. 4.

Review platform 210 can be implemented using one or more computing devices, such as, for example, server computing devices. In the instance that review platform 210 includes multiple computing devices, the computing functions can be distributed according to any computing architecture, including any combination of parallel and sequential computing architectures. Review platform 210 can include one or more processors 251 and a memory 252.

The processor(s) 251 can be any suitable processing device, such as a microprocessor, microcontroller, integrated circuit, or other suitable processing device. The memory 252 can include any suitable computing system or media, including, but not limited to, non-transitory computer-readable media, RAM, ROM, hard drives, flash drives, or other memory devices.

The memory 252 can store information accessible by processor(s) 251, including instructions 253 that can be executed by processor(s) 251. The instructions 253 can be any set of instructions that when executed by the processor(s) 251, cause the processor(s) 251 to provide desired functionality, including, for example, performing aspects of the present disclosure.

The memory 252 can also store a plurality of reviews 254 respectively associated with a plurality of commercial entities. Furthermore, information or statistics concerning the reviews can be included in the review data 254 as well. For example, the number and/or quality of reviews associated with a particular product can be included in the review data 254 or otherwise maintained by and accessible from review platform 210.

Review platform 210 can include a user interface module 256. Review platform can implement user interface module to provide and operate a user interface. For example, the user interface can include an offer of an incentive in exchange for a user contributing a review to reviews 254.

According to an aspect of the present disclosure, review incentivization system 208 can operate to incentivize a review of commercial entity or product. In particular, the user can be offered an incentive, via a user interface of either the mobile payment system 202 or the review platform 210, to provide a review of a commercial entity or a product for which the proof of purchase determination module 244 has determined a proof of purchase.

If the user contributes the review, then the contributed review can be added to the plurality of reviews 254 of the review platform 210. Furthermore, in some embodiments, the incentive can be awarded to the user by adding to currency balance 216, storing a new coupon 218, or otherwise interacting with the contributing user's virtual wallet 214 in the mobile payment system 202.

The network 207 can be any type of communications network, such as a local area network (e.g. intranet), wide area network (e.g. Internet), or some combination thereof. In some embodiments, network 207 can include multiple unassociated networks. In general, communications across network 207 can be carried using any type, number, and combination of wired and/or wireless connections, using a variety of communication protocols (e.g. TCP/IP, HTTP), encodings or formats (e.g. HTML, XML), and/or protection schemes (e.g. VPN, secure HTTP, SSL).

### Example Methods

FIG. 3 depicts a flow chart of an example method (300) for incentivizing reviews according to an example embodiment of the present disclosure. Although method (300) will be discussed with reference to system 200 of FIG. 2, method (300) can be performed by any suitable computing system.

In addition, FIG. 3 depicts steps performed in a particular order for purposes of illustration and discussion. Those of ordinary skill in the art, using the disclosures provided herein, will understand that the various steps of method (300) can be omitted, adapted, and/or rearranged in various ways without departing from the scope of the present disclosure.

At (302) data can be obtained from a mobile payment system that indicates that a user has performed a transaction with a commercial entity. For example, review incentivization system 208 can obtain transaction data 219 from mobile payment system 202. The transaction data 219 can describe a transaction between a user and a commercial entity that occurred at a transaction time and a transaction location. In some implementations, the transaction data 219 is obtained in real-time as the transaction occurs. Furthermore, although not explicitly depicted in FIG. 3, in some implementations, the transaction data 219 can include a receipt or other itemized listing of products purchased via the transaction.

At (304) location data can be obtained. The location data can be associated with one or more mobile computing devices associated with the user. For example, review incentivization system 208 can obtain location data describing the historical or present location of one or more mobile computing devices 204. For example, the location data can be obtained from location data database 227 or can be obtained in real-time from a mobile computing device 204.

As an example, the location data 227 can include a plurality of location reports received from a mobile computing device 204. Each location report can provide a time and a geolocation, such as, for example, a latitude and a longitude. However, other formats of location data can be used as well.

Thus, in some embodiments, in order to obtain the benefits of the techniques described herein, the user may be required to allow the collection and analysis of mobile payment system information and location information associated with the user or her device. Therefore, in some embodiments, users may be provided with an opportunity to control whether programs or features collect such information. If the user does not allow collection and use of such information, then the user may not receive the benefits of the techniques described herein. The user can also be provided with tools to revoke or modify consent. In addition, certain information or data can be treated in one or more ways before it is stored or used, so that personally identifiable information is removed.

At (306) it can be determined whether the user was located at the commercial entity at the time of the transaction. For example, at (306) the location data obtained at (304) can be compared with the data obtained from the mobile payment system at (302) to determine whether the user was located at the commercial entity at the time of the transaction.

Thus, in some implementations, the location of the transaction can be provided by the data obtained from the mobile payment system at (302). In other implementations, the location of the commercial entity can be obtained by analyzing geographic data available from a database.

In some embodiments, determining whether the user was located at the commercial entity at (306) can include determining whether one or more of a plurality of location reports provided by the user's mobile computing devices both identifies a geolocation (e.g. a latitude and longitude) that is within a threshold distance from the commercial entity and provides a time that is within a threshold amount of time from the transaction time.

If it is determined at (306) that the user was not at the commercial entity at the time of the transaction, then method (300) can return to (302) and begin again. For example, method (300) can obtain additional data at (302) describing a different transaction.

However, if it is determined at (306) that the user was located at the commercial entity at the time of the transaction, then method (300) can proceed to (308).

At (308) an incentive can be offered to the user to provide a review. For example, in some instances the incentive can be offered to the user to provide a review of the commercial entity.

In other instances the incentive can be offered to the user to provide a review of a product purchased from the commercial entity. In particular, in some implementations, the transaction data 219 obtained at (302) can identify or otherwise indicate a plurality of different products purchased by the user from the commercial entity. For example, the transaction data 219 can include a receipt or other itemized listing of purchased products. Therefore, in such embodiments, at (308) a particular one of the plurality of purchased items can be selected and then an incentive can be offered to the user to provide a review of the particular, selected product.

For example, review incentivization system 208 can instruct review platform 210 to offer an incentive to the user via a user interface of the review platform 210. As another example, the review incentivization system 208 can instruct mobile payment system 202 to offer an incentive to the user via a user interface of the mobile payment system 202. In yet further embodiments, the incentive can be offered at (308) via email, alongside search or mapping results, via SMS messaging, or other communication avenues.

At (310) it can be determined whether the user has provided a review of the commercial entity or the selected product. For example, review platform 210 can inform review incentivization system 208 and/or mobile payment system 202 when it has received a review from the user concerning the commercial entity. Alternatively, the user can contribute the review to review platform 210 via a portal operated by review incentivization system 208.

If it is determined at (310) that the user has not provided a review of the commercial entity, then method (300) can end. Alternatively, if it is determined at (310) that the user has not provided a review of the commercial entity, then method (300) can return to (302) and obtain data associated with an additional transaction.

However, if it is determined at (310) that the user has provided a review of the commercial entity, the method (300) can proceed to (312).

At (312) the incentive can be awarded to the user. For example, review incentivization system 208 can inform mobile payment system 202 to award the incentive to the user's virtual wallet 214. For example, the incentive can be an amount of currency incremented to the currency balance 216. As another example, the incentive can be a coupon stored in coupons 218.

In such fashion, incentives for reviews are only offered to users who are capable of providing a valid review. In particular, the systems and methods of the present disclosure can determine purchase proof for a user based on mobile payment system data and device location data.

FIG. 4 depicts a flow chart of another example method (400) for incentivizing reviews according to an example embodiment of the present disclosure. Although method (400) will be discussed with reference to system 200 of FIG. 2, method (400) can be performed by any suitable computing system.

In addition, FIG. 4 depicts steps performed in a particular order for purposes of illustration and discussion. Those of ordinary skill in the art, using the disclosures provided herein, will understand that the various steps of method (400) can be omitted, adapted, and/or rearranged in various ways without departing from the scope of the present disclosure.

At (402) data can be obtained from a mobile payment system that indicates that a user has performed a transaction with a commercial entity. For example, review incentivization system 208 can obtain transaction data 219 from mobile payment system 202. The transaction data 219 can describe a transaction between a user and a commercial entity. In some implementations, the transaction data 219 is obtained in real-time as the transaction occurs.

Furthermore, in some implementations, the transaction data 219 can be a receipt or other itemized listing of products purchased via the transaction. For example, the transaction data 219 can include a plurality of barcodes, stock keeping units, product names, product model numbers, or other identifying information describing a plurality of different products.

At (404) one of the plurality of products can be selected based at least in part on review data associated with each of the plurality of products. For example, the review incentivization system 208 can communicate with the review platform 210 to obtain review data 254 about each of the plurality of products evidenced by the transaction data 219.

As an example, the review data 254 can include a number of existing reviews for each product. As another example, the review data 254 can indicate a quality of existing reviews for each product. For example, in some implementations, existing reviews that provide a review value (e.g. 3/5 stars) but do not provide a textual description of the user's experience may be considered of lower quality than reviews that do provide such a textual description. In other implementations, existing reviews can be assigned a quality score based on author reputation or other variables, including the presence of text.

Thus, at (404) one of the plurality of products included in the transaction for which data was obtained at (402) can be selected based at least in part on such review data. As an example, the product which has the smallest number of existing reviews can be selected. As another example, the product which has the lowest quality reviews can be selected at (404). Other combinations of factors can be considered when selecting a particular product at (404), as well.

At (408) an incentive can be offered for the user to provide a review of the product selected at (404). For example, review incentivization system 208 can instruct review platform 210 to offer an incentive to the user via a user interface of the review platform 210. As another example, the review incentivization system 208 can instruct mobile payment system 202 to offer an incentive to the user via a user interface of the mobile payment system 202. In yet further embodiments, the incentive can be offered at (408) via email, alongside search or mapping results, via SMS messaging, or other communication avenues.

At (410) it can be determined whether the user has provided a review of the selected product. For example, review platform 210 can inform review incentivization system 208 and/or mobile payment system 202 when it has received a review from the user concerning the selected product. Alternatively, the user can contribute the review to review platform 210 via a portal operated by review incentivization system 208.

Furthermore, in some embodiments, a review of the commercial entity contributed by the user may satisfy the offer even though the offer requests a review of the selected product.

If it is determined at (410) that the user has not provided a review of the selected product, then method (400) can end. Alternatively, if it is determined at (410) that the user has not provided a review of the selected product, then method (400) can return to (404) and select a different one of the plurality of products included in the transaction. As another alternative, if it is determined at (410) that the user has not provided a review of the selected product, then method (400) can return to (402) and obtain additional transaction data describing a different transaction.

However, if it is determined at (410) that the user has provided a review of the selected product, the method (400) can proceed to (412).

At (412) the incentive can be awarded to the user. For example, review incentivization system 208 can inform mobile payment system 202 to award the incentive to the user's virtual wallet 214. For example, the incentive can be an amount of currency incremented to the currency balance 216. As another example, the incentive can be a coupon stored in coupons 218. In such fashion, incentives for reviews are only offered to users who are capable of providing a valid review.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for incentivizing reviews, the method comprising:
obtaining, by one or more computing devices, data from a mobile payment system indicating that a user has performed a transaction with a commercial entity, the transaction having a transaction time;
obtaining, by the one or more computing devices, location data associated with one or more mobile computing devices associated with the user;
determining, by the one or more computing devices, whether the user was located at the commercial entity at the transaction time based at least in part on the location data; and
when it is determined that the user was located at the commercial entity at the transaction time, providing, by the one or more computing devices, an incentive for the user to provide a review of the commercial entity.

2. The method of claim 1, further comprising awarding, by the one or more computing devices, the incentive to the user when it is determined that the user has provided the review of the commercial entity.

3. The method of claim 2, wherein the incentive comprises an amount of currency, the amount being based on a value of the transaction.

4. The method of claim 3, wherein awarding, by the one or more computing devices, the incentive to the user comprises incrementing, by the one or more computing devices, a balance of a virtual wallet associated with the user by the amount of currency, and wherein the virtual wallet is a component of the mobile payment system.

5. The method of claim 2, wherein the incentive comprises a coupon.

6. The method of claim 5, wherein awarding, by the one or more computing devices, the incentive to the user comprises storing, by the one or more computing devices, the coupon in a virtual wallet associated with the user, and wherein the virtual wallet is a component of the mobile payment system.

7. The method of claim 1, wherein the review comprises a review of a product purchased from the commercial entity.

8. The method of claim 1, wherein providing, by the one or more computing devices, an incentive for the user to provide a review of the commercial entity comprises providing, by the one or more computing devices, an incentive for the user to provide, via a review platform operated by a first entity, a review of the commercial entity, and wherein the first entity also operates the mobile payment system.

9. The method of claim 1, wherein the mobile payment system is operated by a first entity, the first entity being unrelated to the commercial entity.

10. The method of claim 1, wherein the user employed the one or more mobile computing devices to perform the transaction with the commercial entity.

11. The method of claim 1, wherein:
the location data associated with the one or more mobile devices associated with the user comprises a plurality of location reports received from the one or more mobile devices associated with the user, each of the plurality of location reports providing a geolocation and a time; and
determining, by the one or more computing devices, whether the user was located at the commercial entity at the transaction time based at least in part on the location data comprises determining, by the one or more computing devices, whether one or more of the plurality of location reports provides a geolocation that is within a threshold distance from the commercial entity and provides a time that is within a threshold amount of time from the transaction time.

12. A system for incentivizing reviews, the system comprising:
a mobile payment system comprising one or more computing devices, the mobile payment system being configured to:
maintain a virtual wallet for a user; and
process a transaction between the user and a commercial entity, the transaction having a transaction time;
a review incentivization system comprising one or more computing devices, the review incentivization system being configured to:
determine whether the user was located at the location of the commercial entity at the transaction time based at least in part on location data obtained from one or more mobile devices associated with the user; and
when it is determined that the user was located at the location of the commercial entity at the transaction time, provide an incentive for the user to provide a review of the commercial entity.

13. The system of claim 12, further comprising:
a review system comprising one or more computing devices, the review system being configured to receive the review of the commercial entity from the user;
wherein the review incentivization system is further configured to award the incentive to the user when the review system receives the review of the commercial entity from the user.

14. The system of claim 13, wherein the review incentivization system is configured to provide the incentive for the user to provide the review of the commercial entity via a user interface of the review system or via a user interface of the mobile payment system.

15. The system of claim 13, wherein the review incentivization system is configured to award the incentive to the user by communicating with the mobile payment system to increment a balance of the virtual wallet for the user by an amount of currency or to store a coupon in the virtual wallet.

16. The system of claim 13, wherein the one or more mobile devices associated with the user were used to perform the transaction between the user and the commercial entity.

17. A method for incentivizing reviews, the method comprising:
obtaining, by one or more computing devices, transaction data from a mobile payment system, the transaction data describing a transaction processed by the mobile payment system, wherein the transaction comprises a plurality of products purchased by a user from a third-party commercial entity;
selecting, by the one or more computing devices, one of the plurality of products based at least in part on review data associated with each of the plurality of products; and
offering, by the one or more computing devices, an incentive to the user to provide a review of the selected product;
wherein the third-party commercial entity is unaffiliated with the mobile payment system.

18. The method of claim 17, wherein selecting, by the one or more computing devices, one of the plurality of products based at least in part on review data associated with each of the plurality of products comprises:
determining, by the one or more computing devices, a number of existing reviews for each of the plurality of products; and
selecting, by the one or more computing devices, the one of the plurality of products based at least in part on the number of existing reviews for each of the plurality of products.

19. The method of claim 18, wherein selecting, by the one or more computing devices, the one of the plurality of products based at least in part on the number of existing reviews for each of the plurality of products comprises selecting, by the one or more computing devices, the product that has the smallest number of existing reviews.

20. The method of claim 17, wherein the transaction data comprises an itemized receipt of the transaction.
